(19) United States
(12) Patent Application Publication
(10) Pub. No.: US 2015/0247483 A1
(43) Pub. Date: Sep. 3, 2015

(54) STARTER

(71) Applicant: DENSO CORPORATION, Kariya-city (JP)

(72) Inventors: Tomoya IMANISHI, Obu-shi (JP); Tasuku YAMADA, Kariya-shi (JP)

(21) Appl. No.: 14/636,566

(22) Filed: Mar. 3, 2015

(30) Foreign Application Priority Data
Mar. 3, 2014 (JP) 2014-040035

(51) Int. Cl. F02N 15/06; F16H 55/17

(52) U.S. Cl. CPC F02N 15/067; F16H 55/17

(57) ABSTRACT

A first distance between a position where a point-of-action end abuts at a rear end surface of a push-side abutting portion (flat washer) forming a part of holder and a rotational axis of a pinion, and a second distance between a position where the pinion abuts at a front end surface and the rotational axis of the pinion have the relation of first distance>second distance. Thereby, after starting an engine, even when the pinion is rotated at high speed, the push-side abutting portion is less likely to rotate and remains stationary relative to the lever, and even though the push-side abutting portion begins to rotate, it is rotated at a lower speed than the pinion.

### CROSS-REFERENCE TO RELATED APPLICATION

This application is based on and claims the benefit of priority from earlier Japanese Patent Application No. 2014-40035 filed Mar. 3, 2014, the description of which is incorporated herein by reference.

### TECHNICAL FIELD

The present disclosure relates to a starter for starting an engine.

### BACKGROUND

Conventionally, a starter that pushes a pinion to a front in an axial direction by rotating a resin-made lever using a magnetic attraction force of an electromagnetic switch, and starts an engine by rotating the pinion by a torque of an electric motor is known.

Then, after the engine has started, a transmission of the torque between the electric motor and the engine is cut off by a one-way clutch.

In addition, members to be pushed by the lever other than the pinion include a holder or the like for accommodating a point-of-action end of the lever.

The pinion, the holder, and the like are pushed in the axial direction integrally by the point-of-action end of the lever pushing the holder and the holder pushing the pinion (hereinafter, members pushed by the lever will be collectively referred to as a pinion moving body).

The attraction force of the electromagnetic switch is necessary to be stronger as the mass of the pinion moving body becomes larger.

Thus, a pinion shift structure not including a one-way clutch to the pinion moving body and providing the pinion and the one-way clutch as separate bodies is advantageous in that the electromagnetic switch can be miniaturized (refer to Japanese Patent Application Laid-Open Publication No. 09-209890, and Japanese Patent Publication No. 4552924, for example).

Incidentally, in the starter, the pinion is rotated at high speed after the engine has started.

Therefore, the holder is also rotated at high speed in the starter provided with the pinion and the holder integrally as disclosed in the Publication '890.

Moreover, since the point-of-action end of the lever and the holder are abutting in a small area, and the surface pressure is high, there is a possibility that the point-of-action end of the lever may melt due to wear or heat generated when the pinion and the holder are rotated at high speed.

Moreover, the Publication '924 discloses a structure that the holder is assembled so that it can rotate relative to the pinion while slid-contacting thereto, and the holder and the pinion are abutting in a large area.

According to this structure, even if the pinion is brought into a slide-contacting rotation with respect to the holder, because the surface pressure between the holder and the pinion are lowered, wear and heat generation between the holder and the pinion are considered to be suppressed.

However, similarly to the Publication '890, the point-of-action ends and the holder of the lever are abutting in a small area, and the surface pressure is in a high state.

For this reason, even in the structure of the Publication '924, there is a possibility that the point-of-action end of the lever may melt due to wear or heat generated when the holder is rotated at high speed.

In addition, a structure for restricting the rotation of the holder by engaging the point-of-action end of the lever with the holder is disclosed in the Publication '924.

However, since it is necessary to engage the point-of-action end of the lever and the holder, an adjustment of a circumferential angle of the holder becomes necessary when assembling the lever and assembly operability is deteriorated.

### SUMMARY

An embodiment provides a starter employing a pinion shifting structure that can reduce a possibility of a point-of-action end of a lever being melted due to wear or heat generation when a pinion rotates at high speed.

In a starter according to a first aspect, the starter includes a pinion pushed to a front in an axial direction by receiving a magnetic attraction force of an electromagnetic switch as thrust acting in the axial direction, and rotated by a torque of an electric motor.

The starter further includes a resin-made lever assembled rotatably around a predetermined fulcrum, which has a point-of-action end for transmitting the magnetic attraction force as thrust to the pinion.

The starter further includes a push-side abutting portion assembled to the pinion relatively rotatably, pushed to the front in the axial direction in response to an abutment of the point-of-action end of the lever when the lever is rotated by the attraction force, and the push-side abutting portion abutting the pinion from the rear in the axial direction to push the pinion to the front in the axial direction.

The push-side abutting portion has two end surfaces perpendicular to the axial direction formed in a flange shape; one of the end surfaces receives the abutment of the point-of-action end of the lever, while the other one of the end surfaces abuts the pinion from the rear in the axial direction.

A first distance between a position where the point-of-action end of the lever abuts at one of the end surfaces and a rotational axis of the pinion, and a second distance between a position where the pinion abuts at the other one of the end surfaces and the rotational axis of the pinion have a relation that the first distance is greater than the second distance.

Thereby, from the relation that the first distance is greater than the second distance, friction torque acting between the point-of-action end of the lever and the push-side abutting portion can be made greater than friction torque acting between the push-side abutting portion and the pinion.

Therefore, even when the pinion is rotated at high speed, the push-side abutting portion is less likely to rotate and remains stationary relative to the lever, and even though the push-side abutting portion begins to rotate, it is rotated at a lower speed than the pinion.

As a result, since a slide-contacting rotation against the point-of-action ends can be prevented or relieved, it is possible to reduce the possibility of the point-of-action ends being melted due to wear and heat generated when the pinion is rotating at high speed.

In the starter according to a second aspect, there is further provided a return-side abutting portion assembled to the pinion relatively rotatably at the rear in the axial direction of the push-side abutting portion, pushed to the rear in the axial direction in response to an abutment of the point-of-action end of the lever when the lever is rotated in a opposite direction to when the attraction force is produced.

Both the push-side abutting portion and the return-side abutting portion are made of metal, and are provided and assembled as separate bodies from each other.

In the starter according to a third aspect, the push-side abutting portion is formed by stacking a plurality of flat washers in the axial direction.

In the starter according to a fourth aspect, an outer diameter of the flat washer having an end surface that receives the abutment of the point-of-action end of the lever is larger than an outer diameter of the flat washer having an end surface that abuts the pinion.

In the starter according to a fifth aspect, there is further provided a return-side engagement portion formed as an integral material with the return-side abutting portion and assembled at the front in the axial direction and in an inner peripheral side of the return-side abutting portion, and engages with an engagement portion of the pinion by moving to the rear in the axial direction when the lever is rotated in an opposite direction to when the attraction force is produced.

In the starter according to a sixth aspect, the push-side abutting portion is relatively rotatable with respect to the point-of-action end of the lever.

In the starter according to a seventh aspect, the lever has a resin-made collar rotatable around a rotational axis parallel to a rotational axis of the lever, and the collar acts as the point-of-action end of the lever.

In the starter according to an eighth aspect, the collar has two pieces sandwiching the rotational axis of the pinion, and the two pieces abut to the push-side abutting portion.

### BRIEF DESCRIPTION OF THE DRAWINGS

In the accompanying drawings:

FIG. 1 shows an overall block diagram of a starter (first embodiment);

FIG. 2 shows a partially enlarged view of the starter (first embodiment);

FIG. 3 shows a block diagram of principal components of the starter (first embodiment);

FIG. 4 shows a partially enlarged view of the starter (second embodiment);

FIG. 5 shows a partially enlarged view of the starter (third embodiment);

FIG. 6 shows a block diagram of principal components of the starter (third embodiment);

FIG. 7A shows a front view of a lever (third embodiment);

FIG. 7B shows a side view of the lever (third embodiment); and

FIG. 8 shows a block diagram of principal components of the starter (modification).

### DETAILED DESCRIPTION OF THE PREFERABLE EMBODIMENT

### Embodiments

### Configuration of First Embodiment

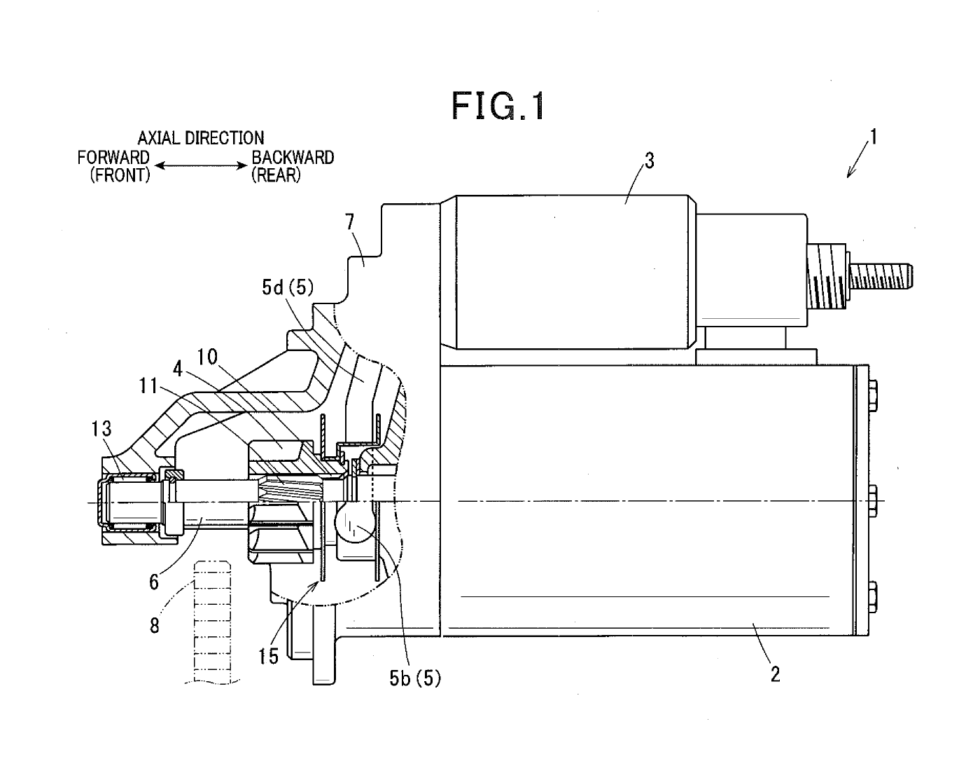

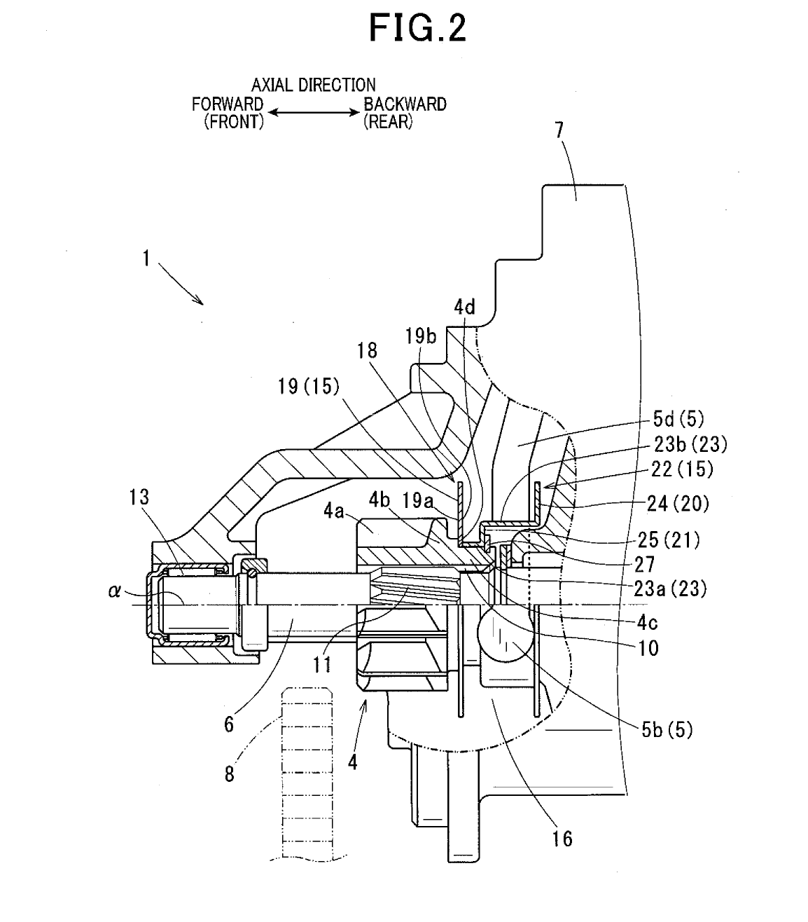

With reference to FIGS. 1 and 2, hereinafter will be described a configuration of the starter 1 of the first embodiment.

A starter 1 is disposed in an engine compartment of a vehicle (not shown.) and is intended to start an engine (not shown.), and the starter 1 has an electric motor 2, an electromagnetic switch 3, a pinion 4, a lever 5, a drive shaft 6, a housing 7, a one-way clutch (not shown.), and the like.

The starter 1 pushes the pinion 4 forwardly in an axial direction by rotating the lever 5 by a magnetic attraction force of the electromagnetic switch 3 so that the pinion 4 engages with a ring gear 8 of the engine, and starts the engine by rotating the pinion 4 by a torque of the electric motor 2.

It should be noted that, after the engine has started, a transmission of the torque between the electric motor 2 and the engine is cut off by the one-way clutch.

Here, the electric motor 2 is intended to generate the torque for starting the engine, and is a well-known DC motor having an armature, a field, a brush, a commutator, and the like.

Further, the electromagnetic switch 3 has a known structure including a coil, a movable contact, and a fixed contact, and advances the pinion 4 in the axial direction by a magnetic attraction force generated by energizing the coil, while the movable contact is brought into contact with the fixed contacts to turn on the power supply to the electric motor 2.

In addition, the electromagnetic switch 3 is assembled with a pushing means such as a coil spring in order to exert a thrust to move back the pinion 4 in the axial direction.

Further, the pinion 4 is pushed to a front in the axial direction by receiving the magnetic attraction force of the electromagnetic switch 3 as thrust acting in the axial direction, and is rotated by the torque of the electric motor 2.

Furthermore, the pinion 4 is fitted through a helical spline to the drive shaft 6 that is assembled coaxially with an output shaft of the electric motor 2.

That is, female helical splines 10 and male helical splines 11 are provided on an inner periphery of the pinion 4 and an outer periphery of the drive shaft 6, respectively, and female and male helical splines 10, 11 are engaged.

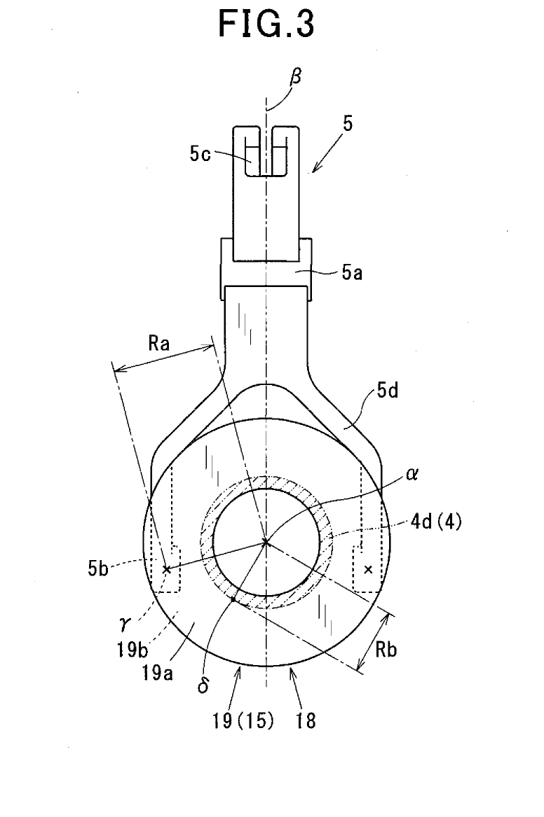

Moreover, the lever 5 is provided with a resin as a material, is assembled rotatably around a predetermined fulcrum 5a, and has point-of-action ends 5b for transmitting the magnetic attraction force of the electromagnetic switch 3 as thrust to the pinion 4 (refer to FIG. 3).

In addition, a power point portion 5c as a power point of the lever 5 is accommodated within the electromagnetic switch 3.

Arms 5d extending to the point-of-action ends 5b from the fulcrum 5a are branched into two, and there are provided two point-of-action ends 5b.

Further, the two point-of-action ends 5b are formed symmetrically in a mirror-image across a plane 13 including a rotational axis α of the pinion 4, and the power point and the fulcrum 5a of the lever 5.

The drive shaft 6 is rotated by being transmitted torque from the electric motor 2 through a planetary gear type speed reducer (not shown.), for example, and is assembled coaxially with the output shaft of the electric motor 2.

In addition, the housing 7 forms an outer shell of a forward side in the axial direction of the starter 1, and accommodates the pinion 4, the drive shaft 6, and the like.

Further, a bearing 13 for rotatably supporting a front end of the drive shaft 6 is accommodated in a front end of the housing 7.

In addition, the one-way clutch has a well-known structure that allows a transmission of the torque of the electric motor 2 to the ring gear 8 via the drive shaft 6 and the pinion 4, and idles after the engine has started to cut off a transmission of the torque of the engine to the output shaft of the electric motor 2 via the drive shaft 6.

According to the above configuration, in the starter 1, an energization to the electromagnetic switch 3 starts when a switch is turned on by a driver, then the lever 5 is rotated and the pinion 4 is advanced, and an energization to the electric motor 2 is turned on thus the electric motor 2 starts outputting the torque.

Thereby, the pinion 4 contacts and engages with the ring gear 8, while the ring gear 8 is rotated by the torque of the electric motor 2 and the engine is started.

Moreover, when the ring gear 8 starts a high speed rotation after the engine has started, the pinion 4 and the drive shaft 6 also rotate at high speed so that the one-way clutch idles, and the transmission of torque between the drive shaft 6 and the electric motor 2 is cut off.

Eventually, when the energization to the electromagnetic switch 3 is stopped, the lever 5 is rotated in a direction opposite to that of advancing the pinion 4 and the pinion 4 moves back in the axial direction, then the pinion 4 is disengaged from the ring gear 8.

In addition, power supply to the electric motor 2 is turned off so that the electric motor 2 stops outputting torque.

Hereinafter, a characteristic configuration of the starter 1 will be described with reference to FIGS. 2 and 3.

First, the pinion 4 has a tooth portion 4a, which has tooth tips, that substantially engages with the ring gear 8, a flange portion 4b that axially continuous rearward from the tooth portion 4a, and a cylindrical cylinder portion 4c that axially extends rearward from the flange portion 4b, and the tooth portion 4a, the flange portion 4b, and the cylinder portion 4c are disposed coaxially.

In addition, an inner peripheral hole penetrates the tooth portion 4a, the flange portion 4b, and the cylinder portion 4c, and the female helical splines 10 are provided on the inner peripheral hole.

Moreover, the starter 1 includes a holder 15 that will be described in detail below.

Here, the holder 15 forms an accommodation space 16 for accommodating the point-of-action ends 5b of the lever 5 and is pushed to the front in the axial direction with the pinion 4 by the thrust transmitted from the electromagnetic switch 3, and the holder 15 is provided separately from the pinion 4.

Further, the holder 15 constitute a pinion moving body together with the pinion 4, and the starter 1 has a pinion shift structure that does not include the one-way clutch in the pinion moving body.

Furthermore, the holder 15 is formed of a flat washer 19 that functions as a push-side abutting portion 18, which is to be described below, and of a special washer 22 that functions as a return-side abutting portion 20 and a return-side engagement portion 21.

In addition, both the flat washer 19 and the special washer 22 are made of metal, and are provided and assembled as separate bodies from each other.

First, the push-side abutting portion 18 is a portion for receiving an abutment of the point-of-action ends 5b when pushing the pinion 4 forward in the axial direction, and occupies a flange-like portion in the to the front in the axial direction side among the holder 15.

Further, the push-side abutting portion 18 is made from a single flat washer 19, and the flat washer 19 is fitted on the outer periphery of the cylinder portion 4c so as a front end and a rear end surfaces 19a, 19b of the flat washer 19 to be perpendicular to the axial direction.

In addition, an inner periphery of the flat washer 19 has substantially the same diameter as that of the outer periphery of the cylinder portion 4c, and the flat washer 19 is assembled to the pinion 4 relatively rotatably.

Moreover, the front end surface 19a opposes to a rear end surface 4d of the flange portion 4b, or abuts with the rear end surface 4d.

Then, the push-side abutting portion 18 receives the abutment of the point-of-action ends 5b at the rear end surface 19b when the lever 5 is rotated by the attraction force of the electromagnetic switch 3.

Further, the push-side abutting portion 18 is pushed to the front in the axial direction by the abutment of the point-of-action ends 5b and abuts the rear end surface 4d from the to the rear in the axial direction by the front end surface 19a, then pushes the pinion 4 to forward in the axial direction.

Here, the push-side abutting portion 18 (flat washer 19) is rotatable relative to the point-of-action ends 5b.

Moreover, a first distance Ra between a position γ where the point-of-action ends 5b abut at the rear end surface 19b and a rotational axis α of the pinion 4, and a second distance Rb between a position δ where the pinion 4 abuts at the front end surface 19a and the rotational axis α of the pinion 4 have a relation of first distance Ra>second distance Rb.

In addition, the flange section 4b reduces its diameter stepwise toward the rear in the axial direction, and an area of the rear end surface 4d is smaller than a cross-sectional area of a portion closer to the front in the axial direction.

Moreover, the return-side abutting portion 20 is a portion that receives the abutment of the point-of-action ends 5b when returning the pinion 4 to the rear in the axial direction.

The return-side abutting portion 20 is a flange-shaped portion at the rear side in the axial direction in the holder 15, and forms the accommodation space 16 by facing the push-side abutting portion 18 in the axial direction.

Here, the return-side abutting portion 20 is a part of the special washer 22 described below.

That is, the special washer 22 is a metal work piece provided by press punching, for example, and has a cylinder portion 23 whose diameter increases stepwise toward the rear in the axial direction, and a ring-shaped flange portion 24 spreading towards the outer peripheral side at a rear end in the axial direction of the cylinder portion 23.

Further, the cylinder portion 23 is formed of a first cylinder portion 23a having a small-diameter disposed in the front side, a second cylinder portion 23b having a large-diameter disposed in the rear side, and a ring-shaped stepped portion 25 that connects a rear end of the first cylinder portion 23a and a front end of the second cylinder portion 23b in the radial direction.

In addition, the first and the second cylinder portions 23a, 23b, the flange portion 24 and the stepped portion 25 are disposed coaxially.

The special washer 22 is fitted to an outer periphery of the cylinder portion 4c so that its axis is substantially coincident with the rotational axis α of the pinion 4, and is rotatable relative to the cylindrical part 4c.

Moreover, a front and a rear end surfaces of the flange portion 24, and a front and a rear end surfaces of the stepped portion 25 are perpendicular to the axial direction.

Here, an engagement portion 27 that abuts the rear end surface of the stepped portion 25 and engages with the stepped portion 25 is provided on the outer periphery of the cylinder portion 4c, and the first cylinder portion 23a and the stepped portion 25 are accommodated between the flat washer 19 and the engagement portion 27.

In other words, the special washer 22 is fitted onto the outer periphery of the cylinder portion 4c by the first cylinder portion 23a and the stepped portion 25.

In addition, a distance in the axial direction between the rear end surface 4d of the flange 4b and the engagement portion 27 substantially matches with a total of an axial length of the first cylinder portion 23a, a thickness of the stepped portion 25, and a thickness of the flat washer 19.

Further, an inner diameter of the first cylinder portion 23a substantially matches with an outside diameter of the cylinder portion 4c.

Then, the return-side abutting portion 20 is composed of the flange portion 24 of the special washer 22.

The return-side abutting portion 20 is pushed to the rear in the axial direction in response to the abutment of the point-of-action ends 5b at the front end surface of the flange portion 24 when the lever 5 is rotated in the opposite direction to the time of action of the attraction force.

Further, the return-side engagement portion 21 is formed of the stepped portion 25 of the special washer 22, and is positioned at the front in the axial direction and in an inner peripheral side of the return-side abutting portion 20.

Then, the return-side engagement portion 21 abuts and engages with the engagement portion 27 by the rear end surface of the stepped portion 25 by moving to the rear in the axial direction when the lever 5 is rotated in the opposite direction to the time of action of the attraction force.

Thus, when the lever 5 is rotated by the attraction force of the electromagnetic switch 3, the point-of-action ends 5b push the push-side abutting portion 18 (flat washer 19) to the front in the axial direction.

Furthermore, by the push-side abutting portion 18 pushing the pinion 4 to the front in the axial direction, the pinion moving body advances forward integrally in the axial direction.

At this time, the special washer 22 advances forward in the axial direction by the engagement portion 27 pushing the stepped portion 25 to the front in the axial direction.

Then, while the pinion 4 abuts and engages with the ring gear 8, the engine is started with the ring gear 8 that is rotated by the torque of the electric motor 2.

Moreover, after the engine has started and the electromagnetic switch 3 stops generating the attraction force, the lever 5 is rotated in the direction opposite to the direction during the advancing movement of the pinion moving body.

Thereby, the point-of-action ends 5b push the return-side abutting portion (flange portion 24 of the special washer 22) to the rear in the axial direction.

Further, by the return-side engagement portion (stepped portion 25 of the special washer 22) pushing the pinion 4 to the rear in the axial direction via the engagement portion 27, the pinion moving body is moved back in the axial direction integrally.

Thus, the pinion 4 is disengaged from the ring gear 8.

### Effect of First Embodiment

According to the starter 1 of the first embodiment, the first distance Ra between the position γ where the point-of-action ends 5b abut at the rear end surface 19b of the push-side abutting portion 18 (flat washer 19) forming the part of the holder 15 and the rotational axis α of the pinion 4, and the second distance Rb between the position δ where the pinion 4 abuts at the front end surface 19a and the rotational axis α of the pinion 4 have the relation of first distance Ra>second distance Rb.

Thereby, friction torque acting between the point-of-action ends 5b and the push-side abutting portion can be made greater than friction torque acting between the push-side abutting portion 18 and the pinion 4.

Therefore, after starting the engine, even when the pinion 4 is rotated at high speed, the push-side abutting portion 18 is less likely to rotate and remains stationary relative to the lever 5.

Further, even though the push-side abutting portion 18 begins to rotate, it is rotated at a lower speed than the pinion 4.

As a result, since a slide-contacting rotation against the point-of-action ends 5b can be prevented or relieved, it is possible to reduce the possibility of the point-of-action ends 5b being melted due to wear and heat generated when the pinion 4 is rotating at high speed.

Further, the return-side abutting portion 20 is the part of the special washer 22 separate from the flat washer 19 that forms the push-side abutting portion 18, and the flat washer 19 and the special washer 22 are both made of metal.

Thereby, it becomes possible to configure the holder 15 to be easily manufactured by press working or the like of the push-side abutting portion 18 and the return-side abutting portion 20.

Therefore, it is possible to provide the holder 15 at a low cost.

Moreover, the return-side engagement portion 21, which is the part of the special washer 22, is assembled to the front in the axial direction and in the inner peripheral side of the return-side abutting portion 20, and when the lever 5 is rotated in the opposite direction to the time of action of the attraction force, the return-side engagement portion 21 moves to the rear in the axial direction and engages with the engagement portion 27 of the pinion 4.

Thus, even an axial length of the pinion 4 is short, the accommodation space 16 is secured and can accommodate the point-of-action ends 5b.

Further, the push-side abutting portion 18 can rotate relative to the point-of-action ends 5b.

Thereby, an adjustment of a circumferential angle of the push-side abutting portion 18 when assembling the lever 5 becomes unnecessary, and it is possible to prevent a deterioration of assembling operability.

### Second Embodiment

It should be appreciated that, in the second embodiment and the subsequent embodiments, components identical with or similar to those in the first embodiment are given the same reference numerals, and structures and features thereof will not be described in order to avoid redundant explanation.

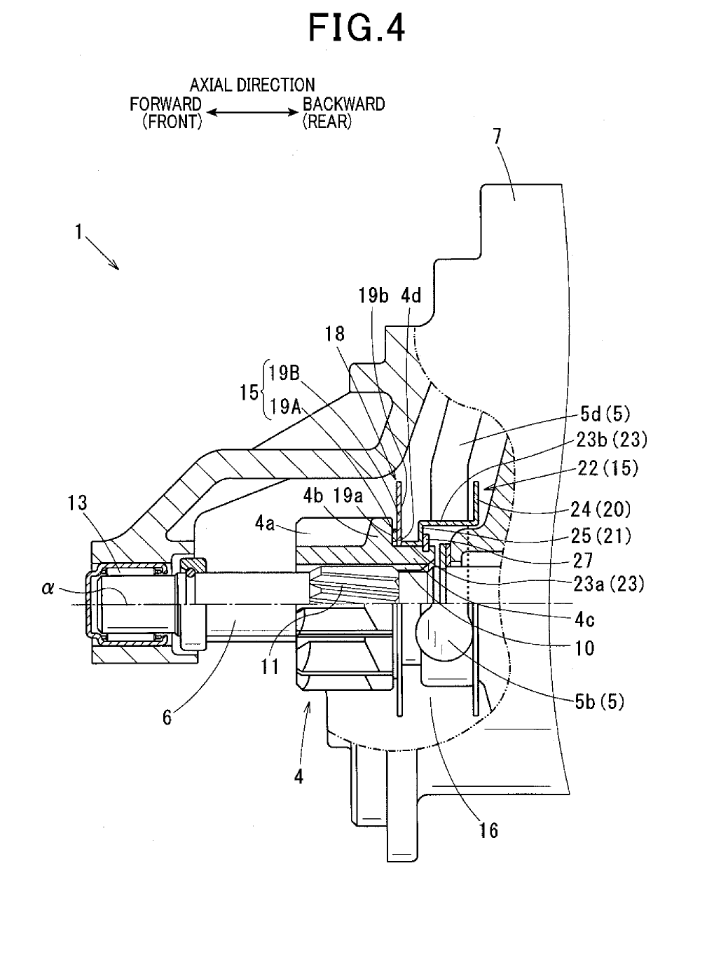

According to the starter 1 of the second embodiment, as shown in FIG. 4, the push-side abutting portion 18 is formed by stacking two sheets of flat washers 19A, 19B in the axial direction.

Then, a front end surface 19a of the flat washer 19A at the front in the axial direction (hereinafter, referred to as the front washer 19A) abuts the rear end surface 4d, and the point-of-action ends 5b abuts a rear end surface 19b of the flat washer 19B at the rear in the axial direction (hereinafter, referred to as the rear washer 19B).

Thereby, even the pinion 4 is rotated at high speed, by the front washer 19A interposed between the pinion 4 and the rear washer 19B, the rear washer 19B may become difficult to rotate, or even though the rear washer 19B begins to rotate, it is rotated at a significantly lower speed than the pinion 4.

Thus, a risk that the point-of-action ends 5b melt when the pinion 4 is rotating at high speed can be further reduced.

Further, an outer diameter of the rear washer 19B is larger than an outer diameter of the front washer 19A.

Thereby, friction torque acting between the rear washer 19B and the point-of-action ends 5b can be made greater than the friction torque acting between the front washer 19A and the pinion 4, or the friction torque acting between the front washer 19A and the rear washer 19B.

Therefore, a slide-contacting rotation is likely to occur between the front washer 19A and the pinion 4, and between the front washer 19A and the rear washer 19B, while the slide-contacting rotation is less likely to occur between the rear washer 19B and the point-of-action ends 5b.

As a result, a risk that the point-of-action ends 5b melt when the pinion 4 is rotating at high speed can be further reduced.

It should be noted that the flange portion 4b of the second embodiment is not reduced in diameter stepwise to the rear in the axial direction, and the outer diameter of the rear end surface 4d is larger than the outer diameter of the front washer 19A.

### Third Embodiment

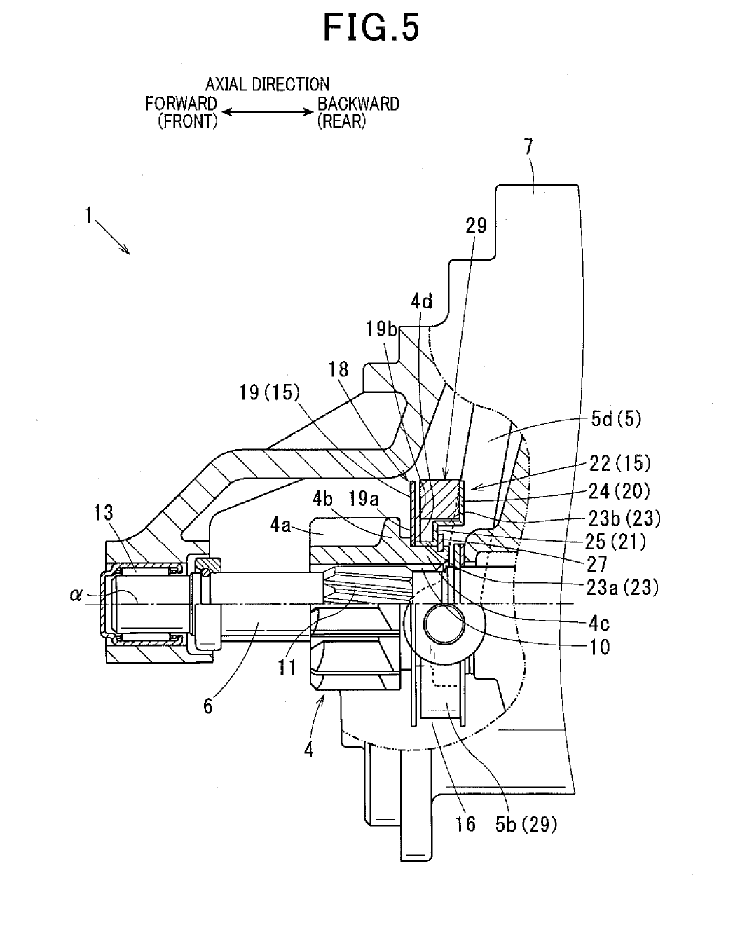

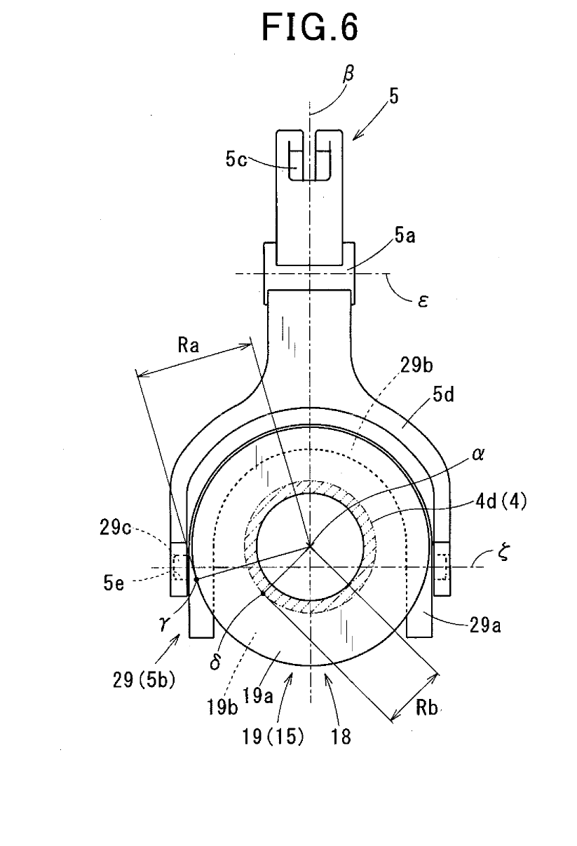

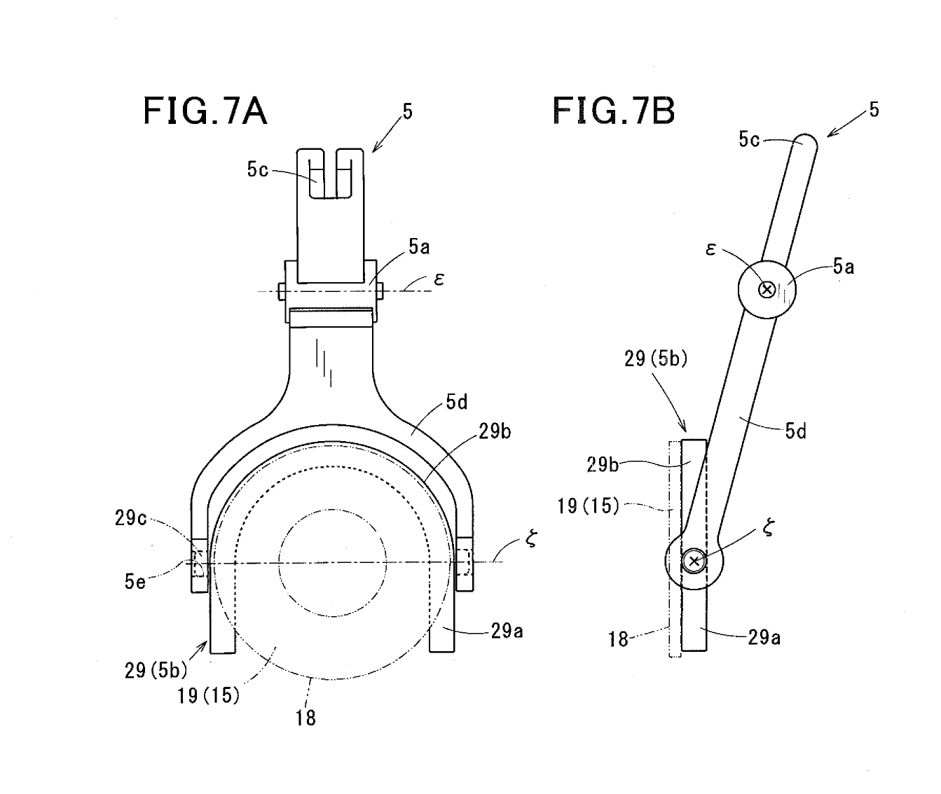

According to the starter 1 of the third embodiment, as shown in FIGS. 5-7A and 7B, the lever 5 has a resin-made collar 29 described below.

In addition, the push-side abutting portion 18 is a single flat washer 19 in the same manner as in the first embodiment.

Further, the flange section 4b reduces its diameter stepwise toward the rear in the axial direction in the same manner as in the first embodiment, and an area of the rear end surface 4d is smaller than a cross-sectional area of a portion closer to the front in the axial direction.

The collar 29 is a resin-made U-shaped component composed of two straight portions 29a and an arc portion 29b, and is supported between the two arms 5d of the lever 5.

Here, in the collar 29, a shaft portion 29c is projected toward outside in respective straight portion 29a, and a shaft hole 5d where the shaft portion 29c is fitted is disposed on an inner side of a tip end of the arm 5e c.

Then, the collar 29 forms a rotational axis ζ parallel to a rotational axis E of the lever 5 by each of the shaft portions 29c is fitted to the respective shaft hole 5e, and is supported rotatably with respect to the lever 5.

Moreover, the arc portion 29b has substantially the same diameter as the flat washer 19, and is assembled so as to rotate above the straight portions 29a.

Then, the collar 29 is accommodated in the accommodating space 16 instead of the arm 5d, and totally forms the point-of-action end 5b of the lever 5.

It should be noted that the collar 29 is formed symmetrically in a mirror-image across a plane β.

Accordingly, it becomes possible to enlarge an abutting area between the point-of-action end 5b and the push-side abutting portion 18.

Therefore, it is possible to increase the friction torque acting between the point-of-action end 5b and the push-side abutting portion 18.

Therefore, even when the pinion 4 is rotated at high speed, the push-side abutting portion 18 is less likely to rotate and remains stationary further relative to the lever 5.

Moreover, even though the push-side abutting portion 18 begins to rotate, it is rotated at a further lower speed than the pinion 4.

Further, by enlarging the abutting area between the point-of-action end 5b and the push-side abutting portion 18, it is possible to reduce a surface pressure between the point-of-action end 5b and the push-side abutting portion 18.

Therefore, even if the push-side abutting portion 18 rotates while contact sliding against the point-of-action ends 5b, it is possible to suppress wear and heat generation between the point-of-action end 5b and the push-side abutting portion 18.

Accordingly, a risk that the point-of-action ends 5b melt when the pinion 4 is rotating at high speed can be further reduced.

Furthermore, according to the collar 29, end portions of the two straight portions 29a not connected to the arc portion 29b are disposed apart.

Therefore, even in a state of supporting the collar 29 pivotally to the lever 5, the workability of assembling of the lever 5 is not reduced.

### [Modification]

Aspects of the starter 1 can be considered various modifications not limited to the embodiments.

For example, according to the starter 1 of the first embodiment, the number of the flat washer 19 of the push-side abutting portion 18 is one, and according to the starter 1 of the second embodiment, the number of the flat washer 19 of the push-side abutting portion 18 is two.

However, the push-side abutting portion 18 may be provided by three or more flat washers 19.

Further, according to the starter 1 of the second embodiment, the push-side abutting portion 18 is provided by stacking two flat washers 19 in the axial direction.

However, the push-side abutting portion 18 may be provided as a single washer by overlapping a plurality of ring-shaped discs having different inner and outer diameters in the axial direction.

For example, the push-side abutting portion 18 may be provided as a single washer by overlapping the front washer 19A and the rear washer 19B used in the second embodiment in the axial direction.

Further, according to the starter 1 of the third embodiment, the collar 29 is the resin-made U-shaped component composed of two straight portions 29a and the arc portion 29b, and the end portions of the two straight portions 29a not connected to the arc portion 29b are disposed apart.

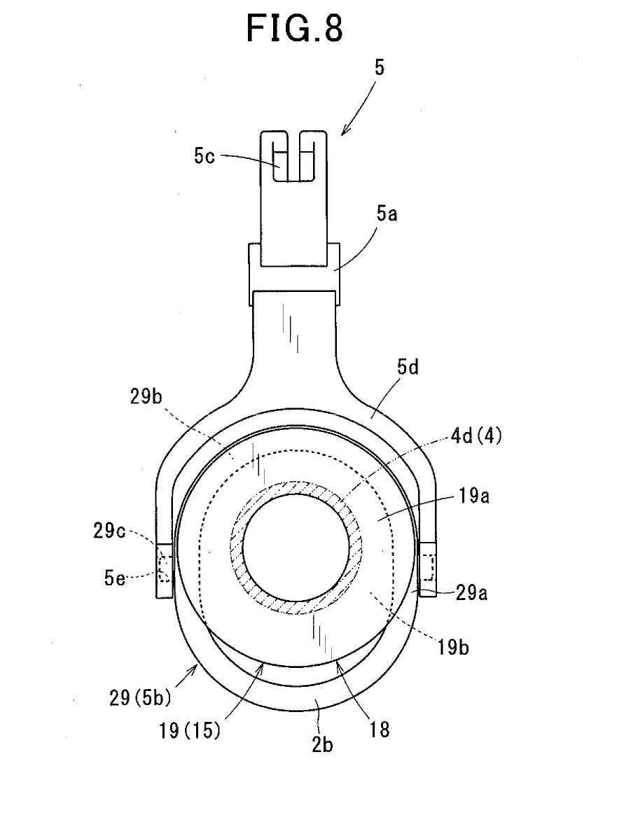

However, as shown in FIG. 8, both ends of the two straight portions 29a may be connected by the arc portions 29b to make the collar 29 into an O-shape.

Furthermore, aspects of the holder 15 are not limited to the embodiments, but it is possible to employ various aspects within a range that achieves the effects of the present disclosure.

For example, a portion having a function of the push-side abutting portion 18 or the return-side abutting portion 20 may be contained in a single metal component.

Moreover, a portion having functions of all the push-side abutting portion 18, the return-side abutting portion 20, and the return-side engagement portion 21 may be contained in a single metal component.

What is claimed is:

1. A starter comprising:
a pinion pushed to a front in an axial direction by receiving a magnetic attraction force of an electromagnetic switch as thrust acting in the axial direction, and rotated by a torque of an electric motor;
a resin-made lever assembled rotatably around a predetermined fulcrum, which has a point-of-action end for transmitting the magnetic attraction force as thrust to the pinion; and
a push-side abutting portion assembled to the pinion relatively rotatably, pushed to the front in the axial direction in response to an abutment of the point-of-action end of the lever when the lever is rotated by the attraction force, and the push-side abutting portion abutting the pinion from the rear in the axial direction to push the pinion to the front in the axial direction; wherein,
the push-side abutting portion has two end surfaces perpendicular to the axial direction formed in a flange shape, one of the end surfaces receives the abutment of the point-of-action end of the lever, while the other one of the end surfaces abuts the pinion from the rear in the axial direction; and
a first distance between a position where the point-of-action end of the lever abuts at one of the end surfaces and a rotational axis of the pinion, and a second distance between a position where the pinion abuts at the other one of the end surfaces and the rotational axis of the pinion have a relation that the first distance is greater than the second distance.

2. The starter according to claim 1, wherein,
there is further provided a return-side abutting portion assembled to the pinion relatively rotatably at the rear in the axial direction of the push-side abutting portion, pushed to the rear in the axial direction in response to an abutment of the point-of-action end of the lever when the lever 5 is rotated in a opposite direction to when the attraction force is produced; and
both the push-side abutting portion and the return-side abutting portion are made of metal, and are provided and assembled as separate bodies from each other.

3. The starter according to claim 1, wherein,
the push-side abutting portion is formed by stacking a plurality of flat washers in the axial direction.

4. The starter according to claim 3,
an outer diameter of the flat washer having an end surface that receives the abutment of the point-of-action end of the lever is larger than an outer diameter of the flat washer having an end surface that abuts the pinion.

5. The starter according to claim 1, wherein,
there is further provided a return-side abutting portion assembled to the pinion relatively rotatably at the rear in the axial direction of the push-side abutting portion, pushed to the rear in the axial direction in response to an abutment of the point-of-action end of the lever when the lever is rotated in a opposite direction to when the attraction force is produced; and
a return-side engagement portion formed as an integral material with the return-side abutting portion and assembled at the front in the axial direction and in an inner peripheral side of the return-side abutting portion, and engages with an engagement portion of the pinion by moving to the rear in the axial direction when the lever is rotated in an opposite direction to when the attraction force is produced.

6. The starter according to claim 1, wherein,
the push-side abutting portion is relatively rotatable with respect to the point-of-action end of the lever.

7. The starter according to claim 1, wherein,
the lever has a resin-made collar rotatable around a rotational axis parallel to a rotational axis of the lever, and the collar acts as the point-of-action end of the lever.

8. The starter according to claim 7,
the collar has two pieces sandwiching the rotational axis of the pinion, and the two pieces abut to the push-side abutting portion.
